(19) United States
(12) Patent Application Publication
(10) Pub. No.: US 2016/0229484 A1
(43) Pub. Date: Aug. 11, 2016

(54) Reciprocal Drive For Hand Powered Vehicles

(71) Applicant: ROTA MOBILITY, INC., Los Gatos, CA (US)

(72) Inventors: Christopher John Bayne, Los Gatos, CA (US); Steven Barker, Sheridan, OR (US)

(73) Assignee: ROTA MOBILITY, INC., Los Gatos, CA (US)

(21) Appl. No.: 14/966,373

(22) Filed: Dec. 11, 2015

Related U.S. Application Data
(63) Continuation-in-part of application No. 14/890,767, filed on Nov. 12, 2015.

(51) Int. Cl. B62M 1/16; B62M 9/00; A61G 5/02; B62M 1/28; B63H 16/18; B62K 5/023

(52) U.S. Cl. CPC B62M 1/16; B63H 16/18; B62K 5/023; A61G 5/022; B62M 1/28; B62M 9/00; A61G 5/025; B62L 1/00

(57) ABSTRACT

Disclosed herein is a reciprocal drive for a hand powered vehicle including a first axle, connected to a propulsion lever that the occupant of the vehicle pushes and pulls in a rowing motion, a first and a second power gear mounted on the first axle, wherein the first and second power gears rotate in opposing directions when the user pushes and pulls the propulsion lever, a first and a second drive belt, wherein the first drive belt delivers propulsive force from the first power gear to a gear wheel when the user pushes the propulsion lever and the second drive belt delivers propulsive force from the second power gear to the gear wheel when the user pulls the propulsion lever, and a second axle, on which the gear wheel is mounted, which rotates a drive wheel of the vehicle.

### REFERENCE TO RELATED APPLICATIONS

This application is a Continuation-In-Part of U.S. patent application Ser. No. 14/890,767 filed on Nov. 12, 2015 by inventors Christopher John Bayne and Steven Barker, which is a national stage filing of International Application No. PCT/US2014/030803, entitled “SCOOTER GENERATING POWER BY ROWING IN BOTH DIRECTIONS”, filed on Mar. 17, 2014 by inventors Christopher John Bayne and Steven Barker which in turn claims priority under 35 USC §119(e) to U.S. provisional application Ser. Nos. 61/801,293, filed Mar. 15, 2013, and 61/873,926, filed Sep. 5, 2013.

### BACKGROUND

Conventional wheelchairs require that an occupant or user of the wheel chair reach and push against each of two wheels, or against levers attached to the two wheels, one on either side of the chair, to rotate the wheels and generate motion.

In contrast, a central lever drive (CLD) vehicle uses a rowing motion in which the user pushes and pulls a central, lever to generate motion. Because the rowing motion permits the user to push and pull the lever across a larger distance compared to other manual propulsion mechanisms the length of the central lever can be greater so the CLD provides increased mechanical advantage (MA) and therefore generates significantly more propulsive power than that generated by a user in a conventional wheelchair or other manually propelled vehicle, for the same amount of applied force. Additionally, The CLD also allows the user to push and pull within their shoulder width. Thus, CLD offers important ergonomic advantages as compared to a conventional wheelchair or as compared to other hand powered vehicles such as hand cranked tricycles, scooters, or boats.

Thus there is a need for a CLD mechanism that may be incorporated into hand powered vehicles in which the power for the vehicle is generated from the occupant's reciprocal rowing motion.

Thus, it is with respect to these considerations and others that the present invention has been made.

### SUMMARY OF THE DESCRIPTION

The inventive reciprocal drive, also known as a reciprocal drive, operates in a variety of hand powered vehicles including inter alia a scooter, a wheelchair, a tricycle and a boat.

In certain embodiments, the reciprocal drive is incorporated into a terrestrial, or land-based, vehicle equipped with at least one front wheel and at least one rear wheel, wherein power for forward motion of the vehicle is developed using a rowing motion, i.e. by pushing and pulling a propulsion lever, the propulsion lever being functionally connected to the reciprocal drive. The reciprocal drive conveys the propulsive force generated by the propulsion lever to one or more drive wheels, which may be in the front or rear of the vehicle. Two opposing one-way clutches ensure that both forward and backward rowing motions result in unidirectional, forward, motion by the vehicle.

In certain embodiments, the reciprocal drive is contained in a rotatable module, allowing the at least one front or rear wheel to be rotated 180 degrees, thereby permitting backward or sideways motion of the scooter-type vehicle by the same pushing and pulling motion of the propulsion lever. The ability to rotate the reciprocal drive 360 degrees may be referred to as turret steering.

In certain embodiments, the present invention the propulsion lever is also employed by the user to steer the vehicle.

The centerpiece of the present invention is a novel, integral and compact reciprocal drive. The rowing motion whereby the vehicle is propelled reduces the incidence of repetitive stress injuries, like carpal tunnel syndrome, in the user, as compared with traditional hand-rim driven wheelchairs. Furthermore, use of the scooter-type vehicle according to the present invention affords good cardiovascular exercise, benefitting the physical health of the user. It is particularly useful for persons who have motor impairments of the lower body (i.e., the legs), but can be used by anyone, regardless of physical impairment.

Regardless of pushing or pulling the propulsion lever, the motion results in uni-directional movement of the drive wheel, or wheels, through the use of opposing one-way clutches. Because the reciprocal drive is compact, and is contained in a small housing at the front of the vehicle, the drive wheel or wheels may be rotated to any degree and in any direction. Thus, after swiveling the drive wheel 180 degrees, the propulsion lever drives the vehicle in a reverse direction.

### BRIEF DESCRIPTION OF THE DRAWINGS

FIG. 1A is an embodiment of a scooter that incorporates a reciprocal drive as seen from the side;

FIG. 1B is a view of the scooter as seen from the rear;

FIG. 1C is a view of the scooter as seen from the underside;

FIG. 1D is a view of the scooter as seen from the front;

FIG. 2A is a view of the propulsion/drive system;

FIG. 2B is another view of the propulsion/drive system;

FIG. 2C is a view of the propulsion/drive system as seen from the underside;

FIG. 3 is a detailed diagram of the propulsion/drive system, in which the transmission configuration can clearly be seen.

FIG. 4 is a detailed diagram of a reciprocal drive that is operable in a variety of hand powered vehicles.

FIG. 5A is a view of a wheelchair that incorporates a reciprocal drive where the reciprocal drive is deployed, i.e. the drive wheel contacts the ground, and the front casters are raised off the ground.

FIG. 5B is a view of the wheelchair in which the drive wheel is elevated and not in use.

FIG. 6 is an illustration of an embodiment of a tricycle that incorporates a reciprocal drive.

### DETAILED DESCRIPTION

The present invention is related to U.S. patent application Ser. No. 13/263,683. Power is generated from both the forward and backward movement of a propulsion lever. However, in the present embodiment, a system of gears and chains generates power in a more compact, integral transmission box, which is directed to the front wheel, which propels the vehicle in a forward motion.

As used herein the following terms have the meanings given below:

Occupant or user—refers to a person in a vehicle powering or propelled by the present invention. The occupant or user sits, kneels or stands within the vehicle and uses a rowing motion to push or pull a propulsion lever that is functionally connected to the reciprocal drive.

Reciprocal drive—also referred to as a transmission/gearbox mechanism is a mechanism that converts a rowing motion, i.e. pushing and pulling, by a user using a central lever, also known as a propulsion lever, into directional motion by one or more wheels or other output devices such as a propeller or paddle.

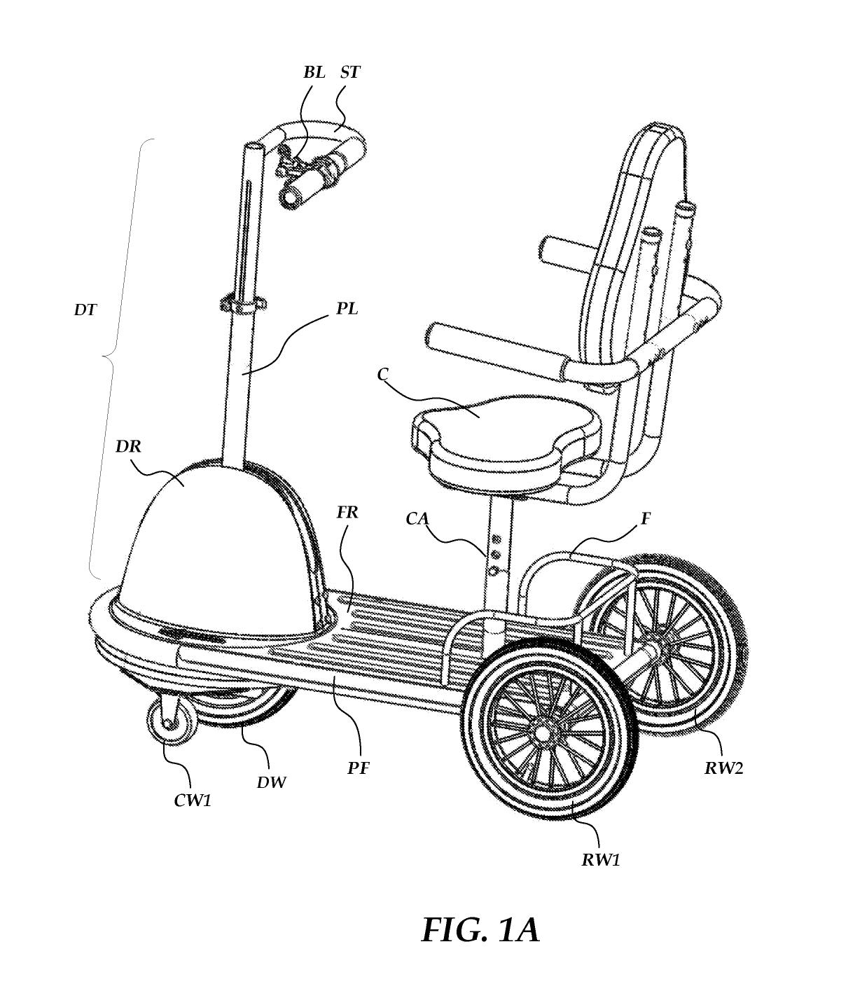

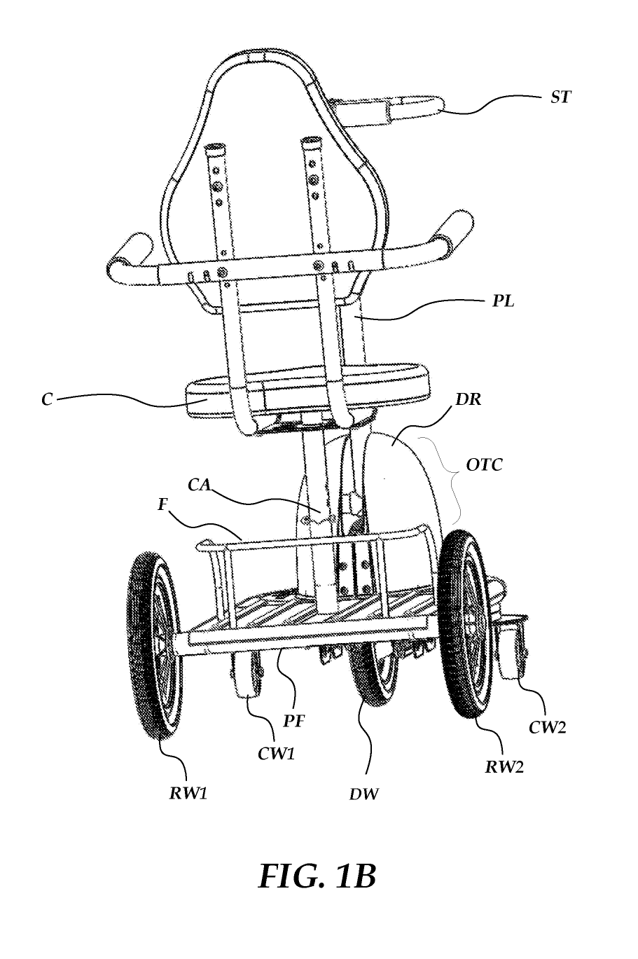

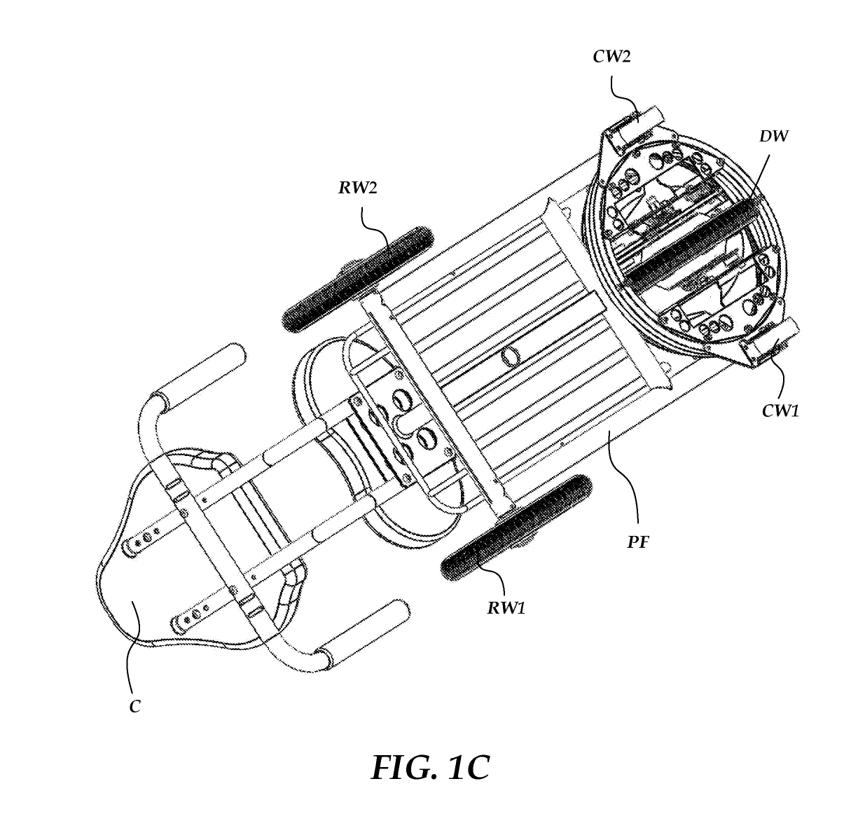

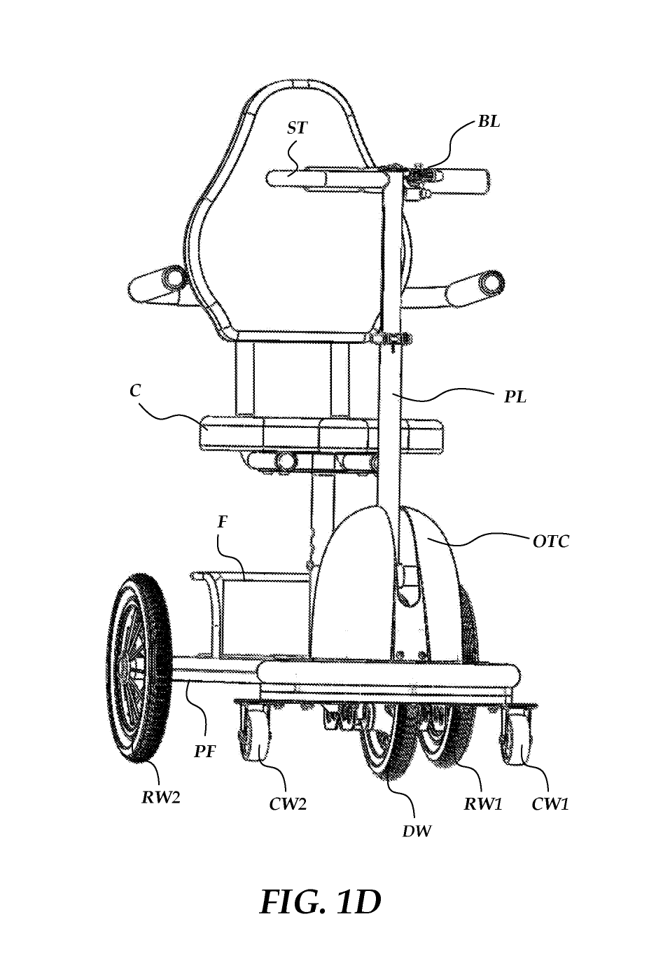

In FIG. 1A, which is a view of the scooter-type vehicle as seen from the side DT denotes the “drive train,” which includes the transmission/gear box (denoted as DR) and propulsion lever (denoted as PL), ST denotes the steering handle, BL denotes the brake lever, FR denotes the footrest for the occupant, DW denotes the drive wheel, through which power is delivered, PF denotes the platform on the bottom of the vehicle, C denotes the seat for the occupant, CA denotes the seat adjustment knob, F denotes a rack for storing items to be carried on the vehicle, RW1 and RW2 denote the rear wheels, CW1 and CW2 denote the wheels on the front of the vehicle for added stability. (CW2 is not shown in the diagram).

In FIG. 1B, which is a view of the scooter-type vehicle as seen from the rear, C denotes the seat for the occupant, CA denotes the seat adjustment knob, ST denotes the steering handle, PL denotes the propulsion lever, DR denotes the transmission/gearbox, OTC denotes the transmission/gearbox housing, F denotes a rack for storing items to be carried on the vehicle, PF denotes the platform on the bottom of the vehicle, RW1 and RW2 denote the rear wheels, CW1, and CW2 denote the caster wheels on the front of the vehicle for added stability.

In FIG. 1C, which is a view of the scooter-type vehicle as seen from the underside, C denotes the seat for the occupant, PF denotes the platform on the bottom of the vehicle, DW denotes the drive wheel, RW1 and RW2 denote the rear wheels, CW1, and CW2 denote the caster wheels on the front of the vehicle for added stability.

In FIG. 1D, which is a view of the scooter-type vehicle as seen from the front, BL denotes the brake lever, ST denotes the steering handle, PL denotes the propulsion lever, C denotes the seat for the occupant, F denotes a rack for storing items to be carried on the vehicle, PF denotes the platform on the bottom of the vehicle, OTC denotes the transmission/gearbox housing, DW denotes the drive (front) wheel, RW1 and RW2 denote the rear wheels, CW1, and CW2 denote front and caster wheels for added stability.

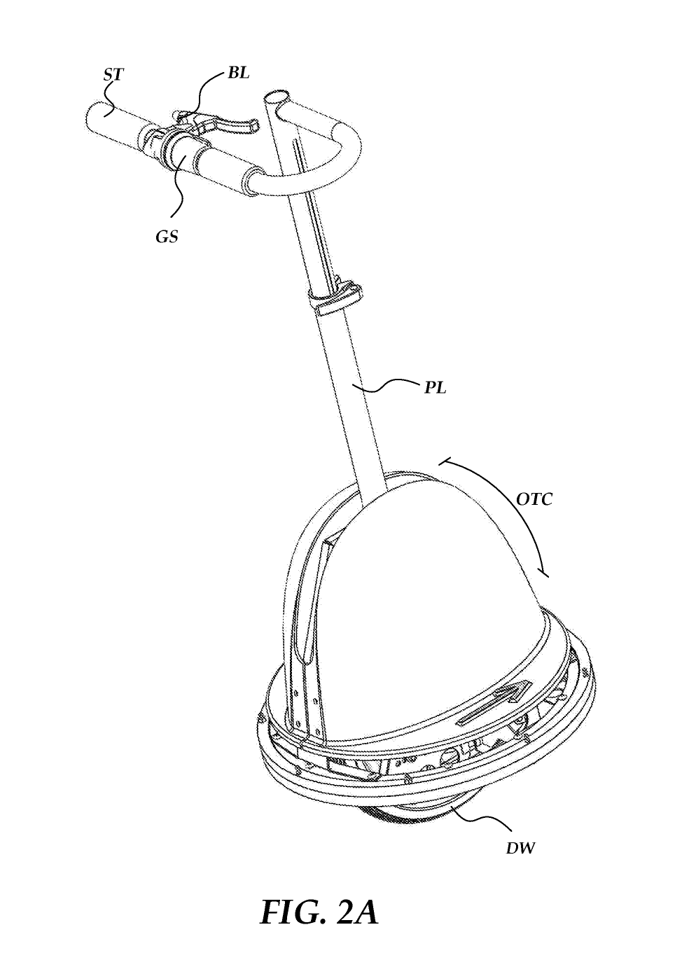

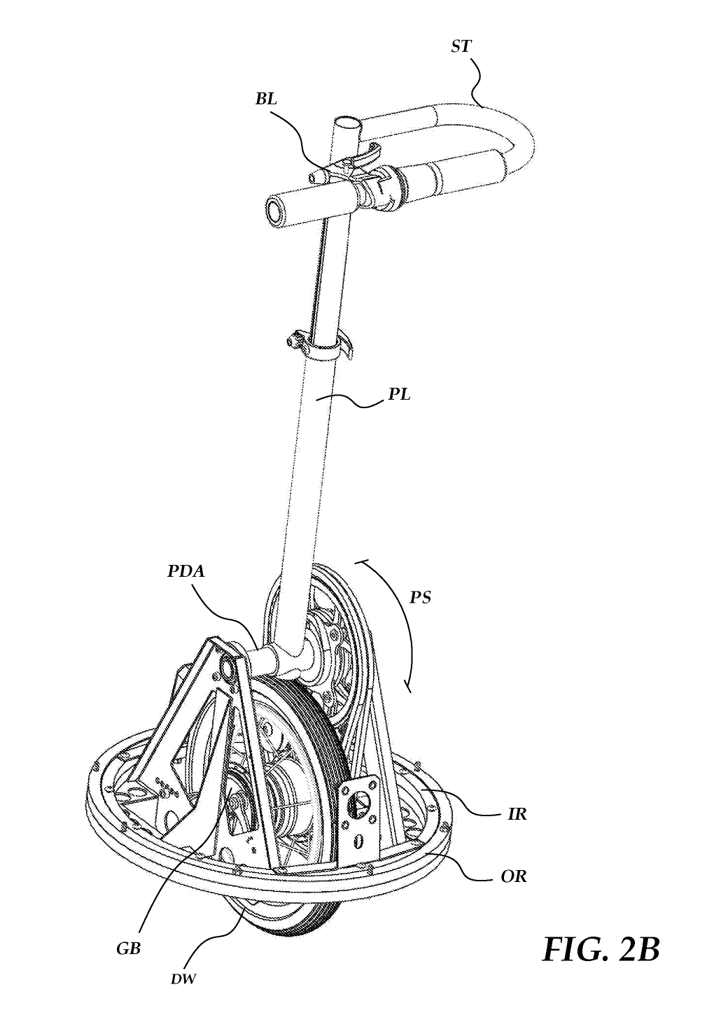

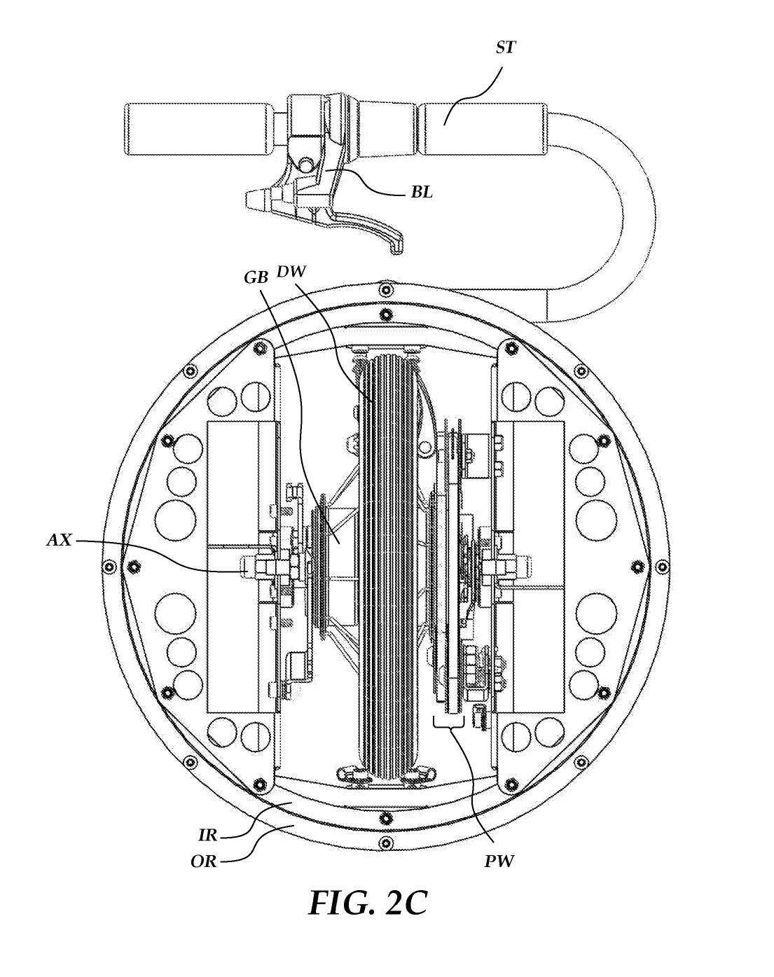

In FIG. 2A, which is a view of the propulsion/drive system, BL denotes the brake lever, GS denotes the gear shifter, ST denotes the steering handle, PL denotes the propulsion lever, OTC denotes the transmission/gearbox housing, and DW denotes the drive (front) wheel.

In FIG. 2B, which is a view of the transmission/gearbox as seen from the rear, BL denotes the brake lever, ST denotes the steering handle, PL denotes the propulsion lever, PS denotes the power gears, PDA denotes the propulsion lever axle, IR denotes the inner ring of the interface of the transmission/gearbox with the bottom platform of the vehicle, OR denotes the outer ring of the interface of the propulsion/drive system with the bottom platform of the vehicle, DW denotes the drive (front) wheel, GB denotes the gearbox.

In FIG. 2C, which is a view of the propulsion/drive system as seen from the underside, BL denotes the brake lever, ST denotes the steering handle, IR denotes the inner ring of the interface of the propulsion/drive system with the bottom platform of the vehicle, OR denotes the outer ring of the interface of the propulsion/drive system with the bottom platform of the vehicle, PW denotes the power gears, DW denotes the drive (front) wheel, AX denotes the front axle, GB denotes the gearbox.

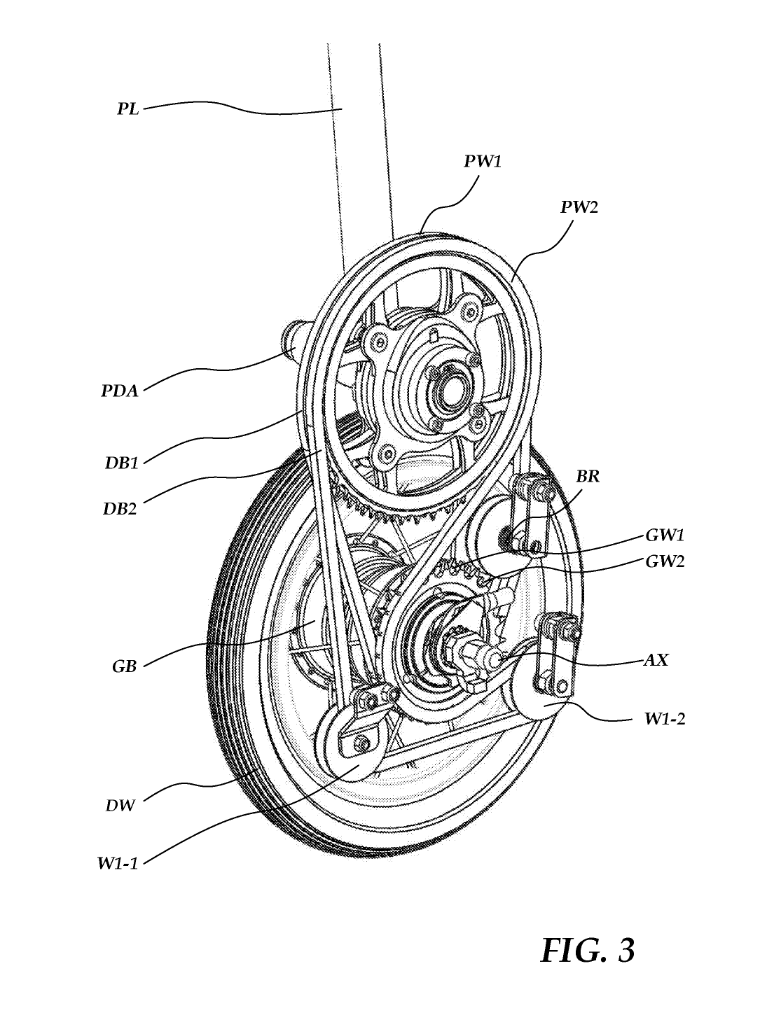

In FIG. 3, which is a detailed diagram of the propulsion/drive system, when propulsion lever (PL) moves in the forward direction it drives power gear 1 PW1 in the forward direction, while the power gear 2 (PW2) rotates in the backward, i.e. reverse, direction, like a bicycle pedaling backwards. Drive belt 1 (DB1) is driven by PW1, so that it moves gear wheel 1 (GW1), which is connected to the gearbox (GB) and the axle (AX). When the propulsion lever (PL) moves in the reverse direction (towards the occupant of the vehicle), power gear 2 (PW2) moves back and drives drive belt 2 (DB2), while PW1 rotates in the forward direction. Drive belt 2 (DB2) changes direction through a series of two gear wheels (W1-1 and W1-2), thus moving drive belt 2 (DB2) forwards when it meets gear wheel 2 (GW2). GW2 is also connected to the gearbox and axle. The net result is that drive wheel (DW) moves in one direction regardless of whether the propulsion lever (PL) is moved forward or backward (toward or away from the occupant of the vehicle). PDA in FIG. 3 denotes the propulsion lever axle, while BR denotes the brake mechanism.

The scooter-type vehicle described herein is modifiable and adaptable in divers ways, which will be obvious to one of ordinary skill in the mechanical arts, without any undue experimentation. For example, rubber belts or linked chains fabricated of metal may be employed in the propulsion/drive system, the wheels may be afforded with pneumatic tires, or solid rubber tires, the frame may be manufactured with different combinations of a variety of materials, such as different metallic alloys, fiberglass, or carbon fiber/epoxy materials, for varying degrees of lightness and strength trade-offs, the seat may be cushioned or not, the brake mechanism may be of the caliper-, disc- or drum-type, and differing degrees of mechanical advantage may be incorporated into the adjustable gearbox.

### Generalized Reciprocal Drive

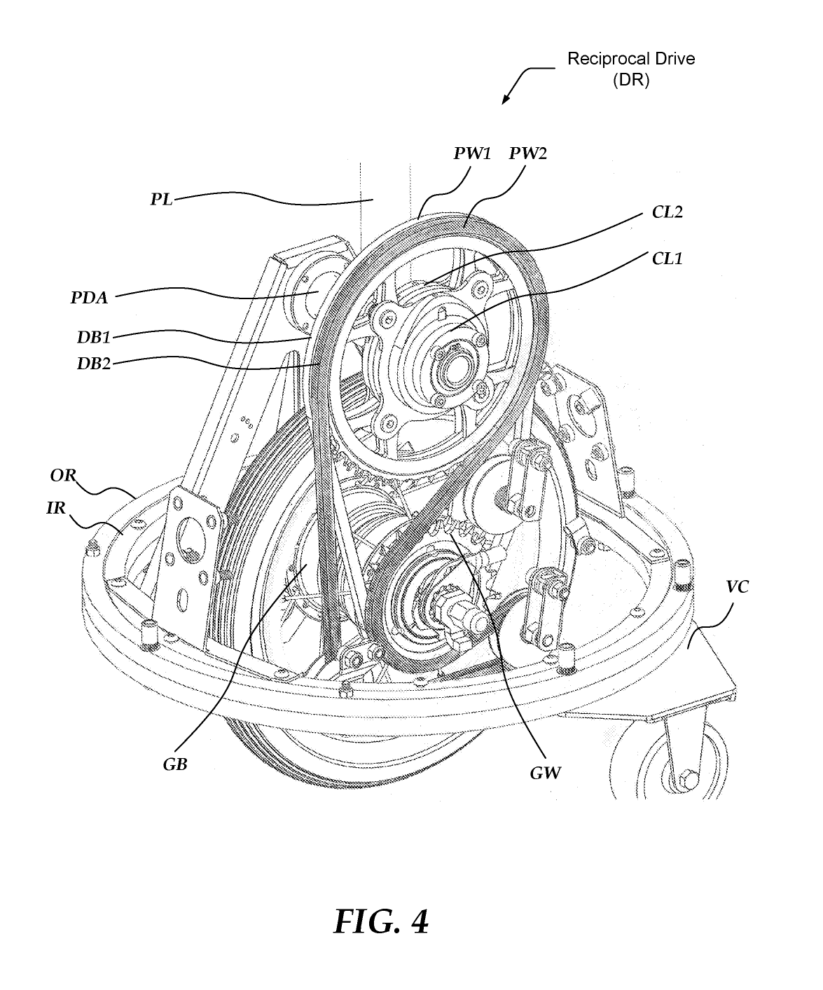

FIG. 4 illustrates an embodiment of a reciprocal drive (DR) suitable for use in a variety of user-powered vehicles. The reciprocal drive depicted in FIG. 4 is substantially identical to that illustrated in FIG. 3 but is further described hereinbelow so as to clarify certain features and to further clarify that it may be used in a wide variety of vehicles in addition to the scooter-type vehicle described with reference to FIGS. 1A-1D. It should also be noted that the term reciprocal drive (DR) is used hereinafter in place of transmission/gearbox mechanism; it being understood that both terms refer to the same device.

The primary objective of the reciprocal drive is to translate the reciprocal motion of pushing and pulling the propulsion lever (PL), performed by the user, into unidirectional rotary output, i.e. a uniform forward motion by the drive wheel (DW). When propulsion lever (PL) is pushed forward by the user, power gear 1 (PW1) moves in the forward direction and power gear 2 (PW2) moves in the reverse direction. However, when propulsion level (PL) is pulled backward by the user, i.e. in the reverse direction, power gear 1 (PW1) moves in the backward direction and power gear 2 (PW2) moves in the forward direction. The two power gears (PW1 and PW2) are both mounted on the propulsion lever axle (PDA) which is also commonly referred to as an input shaft, which, in turn, connects to the propulsion lever (PL).

To determine which of the two power gears (PW1 and PW2), also commonly referred to as sprockets, is engaged and generates the forward power, two one-way clutches, are used. A first clutch (CL1) is associated with power gear 1. When the propulsion lever (PL) is pushed forward the first clutch (CL1) engages and power gear 1 (PW1) drives the lower gear in the forward direction. When propulsion lever (PL) is pulled backward the second clutch (CL2) engages, and conversely the first clutch (CL1) disengages, and power gear 2 (PW2) engages and drives a gear wheel (GW) in the forward direction. The two clutches, first clutch (CL1) and second clutch (CL2) are mounted in opposite directions to ensure that their actions are opposite, i.e. when first clutch (CL1) engages, second clutch (CL2) disengages and vice versa. This results in uniform forward motion being delivered to the drive wheel (DW).

In certain embodiments, commercially available Sprag clutches are used for both the first clutch (CL1) and the second clutch (CL2). A Sprag clutch is a one-way freewheel clutch such that the unit rotates in one direction.

In certain embodiments, the gear wheel (GW) is a single element that includes gear wheel 1 (GW1) and gear wheel 2 (GW2), as depicted in FIG. 3. The gear wheel (GW) always turns in the forward or clockwise direction. Thus, when the drive wheel (DW) faces forward this results in forward motion on the part of the vehicle; and when the drive wheel (DW) faces backward this results in backward motion on the part of the vehicle. In general, using the propulsion lever (PL), the user can position the drive wheel (DW) to point at any angle, and thus travel in any direction. The ability of the reciprocal drive (DR) to rotate freely through 360 degrees may be referred to as “turret steering”. Power gear 1 is functionally connected with the gear wheel (GW) through a first linkage, or drive belt, (DB1), while power gear 2 is functionally connected with the gear wheel (GW) through a second linkage, or drive belt, (DB2). In one embodiment, as described with reference to FIG. 3, drive belt 2 (DB2) changes direction through a series of two gear wheels (W1-1 and W1-2, illustrated in FIG. 3); this results in drive belt 2 (DB2) moving in the forward direction across the gear wheel (GW) when the user pulls the propulsion lever (PL). Thus, when the user pushes the propulsion lever (PL) power gear 1 engages and delivers the propulsive force to the gear wheel (GW) via drive belt 1 (DB1); conversely, when the user pulls the propulsion lever (PL) power gear 2 engages and delivers propulsive force to the gear wheel (GW) via drive belt 2 (DB2). Typical linkage or drive belt mechanisms include inter alia rubber belts and metal chains.

In certain embodiments, gear box (GB) provides a plurality of gears; in other embodiments, gear box (GB) may not be present or may provide a single gear. Gear box (GB), as depicted in both FIGS. 3 and 4, may be an internal hub gear such as those commonly used in bicycles. In certain embodiments, the user controls shifting of gears using a hand-controlled shifting mechanism mounted on the steering handle (ST) of FIG. 1A. The shifting mechanism is typically linked via a cable to the gear box (GB).

In certain embodiments, gear box (GB) also includes an internal braking system that is activated by a hand controlled brake such as brake lever (BL) of FIG. 1A. The brake is typically linked via a cable to braking component of gear box (GB).

The reciprocal drive is bolted to an inner ring (IR) that can freely rotate within an outer ring (OR) via bearings set in between the inner ring (IR) and outer ring (OR). The outer ring (OR) in turn is bolted to the chassis of a vehicle (VC), thus enabling the reciprocal drive to swivel with respect to the vehicle. While the bearings are not illustrated, this mechanism is known in the art as a “lazy susan” turntable, typically used for swiveling televisions, serving trays and cabinets, in which an inner ring rotates freely inside an outer ring through the use of bearings.

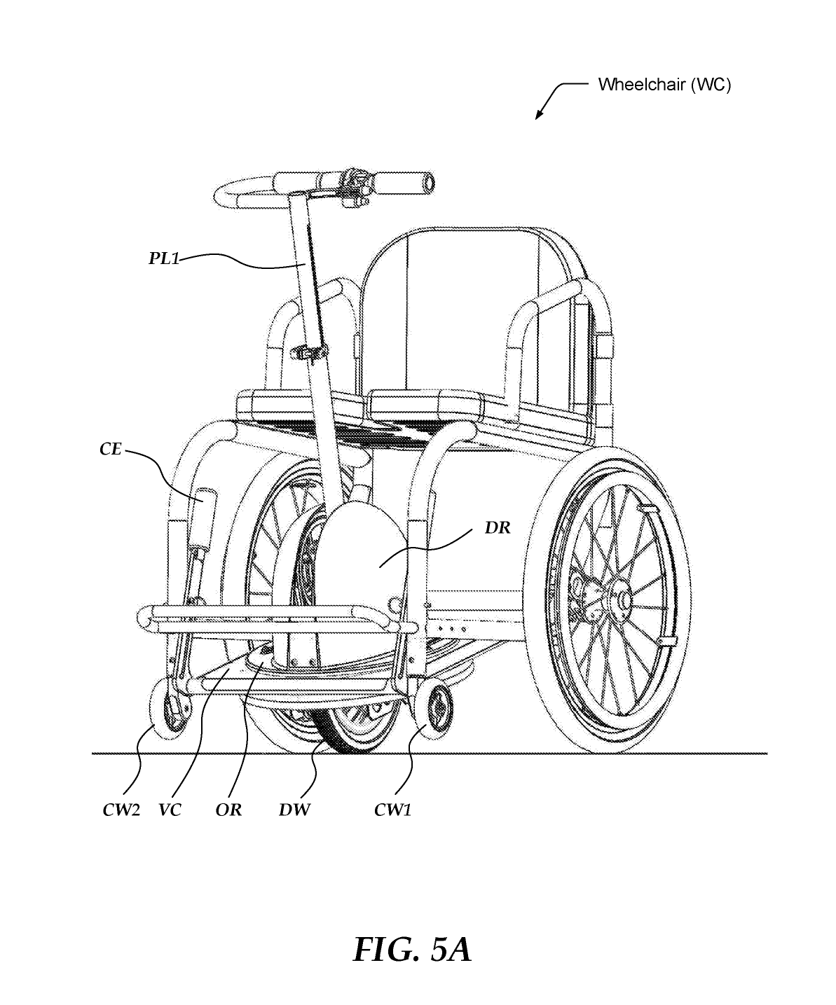

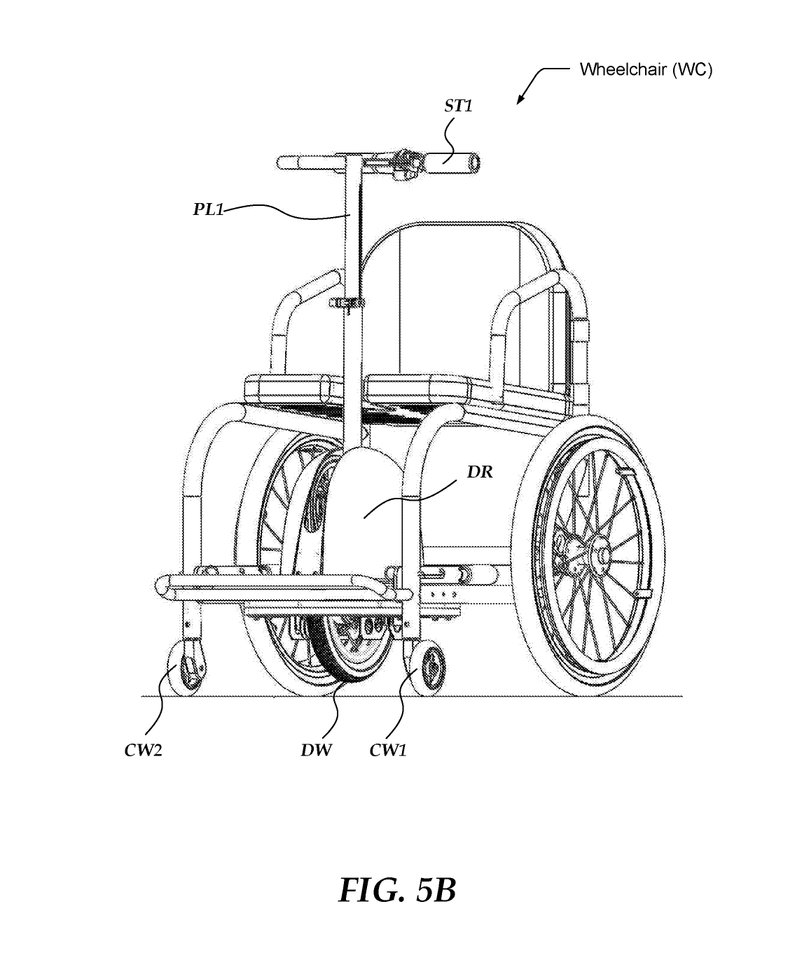

FIG. 5A is a view of the wheelchair where the reciprocal drive (DR) is deployed, i.e. the drive wheel (DW) contacts the ground, and the front casters are raised off the ground. In this mode of operation, the function of the reciprocal drive (DR) is the same as described with reference to FIG. 4 hereinabove. The wheelchair (WC) incorporates the reciprocal drive (DR) illustrated in FIG. 4 as well as a propulsion lever (PL1), which is similar and in certain embodiments identical to propulsion lever (PL). In this embodiment, as illustrated, the propulsion lever (PL1) includes a brake handle and a gear shifter. The user of the wheelchair (WC) employs a rowing motion to push the propulsion lever (PL1) forward and backwards. The reciprocal drive (DR) is fixed, typically using bolts, to the chassis (VC) of wheelchair (WC). It may be appreciated that the reciprocal drive (DR) is illustrated as including a reciprocal drive housing. In certain embodiments reciprocal drive (DR) includes a housing while in other embodiments a housing may not be included.

FIG. 5B is a view of the wheelchair (WC) in which the drive wheel is elevated and not in use. In this mode the front casters rest on the ground to enable the use of the push-rims, attached to the outside of each rear wheels, to maneuver the wheelchair in extremely confined spaces. To enable the user to rotate or swivel the reciprocal drive (DR), in order, for example, to swivel the drive wheel (DW) 180 degrees in order to move backwards, the wheel chair (WC) provides a control (CE), depicted in FIG. 5A, that enables the user to elevate the reciprocal drive (DR) mechanism, including the drive wheel (DW) and propulsion lever (PL) off the ground. When the reciprocal drive (DR) is in such an elevated position the user can swivel the reciprocal drive 180 degrees, or to any desired position, using a steering handle (ST1), and then lower the reciprocal drive (DR) such that the drive wheel (DW) rests on the ground. At this point the user can commence the rowing motion and the wheelchair (WC) will move in the direction indicated by the drive wheel (DW). It may be appreciated that steering handle (ST1) may be similar or identical to the steering handle (ST) described with reference to FIGS. 1A-D, or it may be different in various respects.

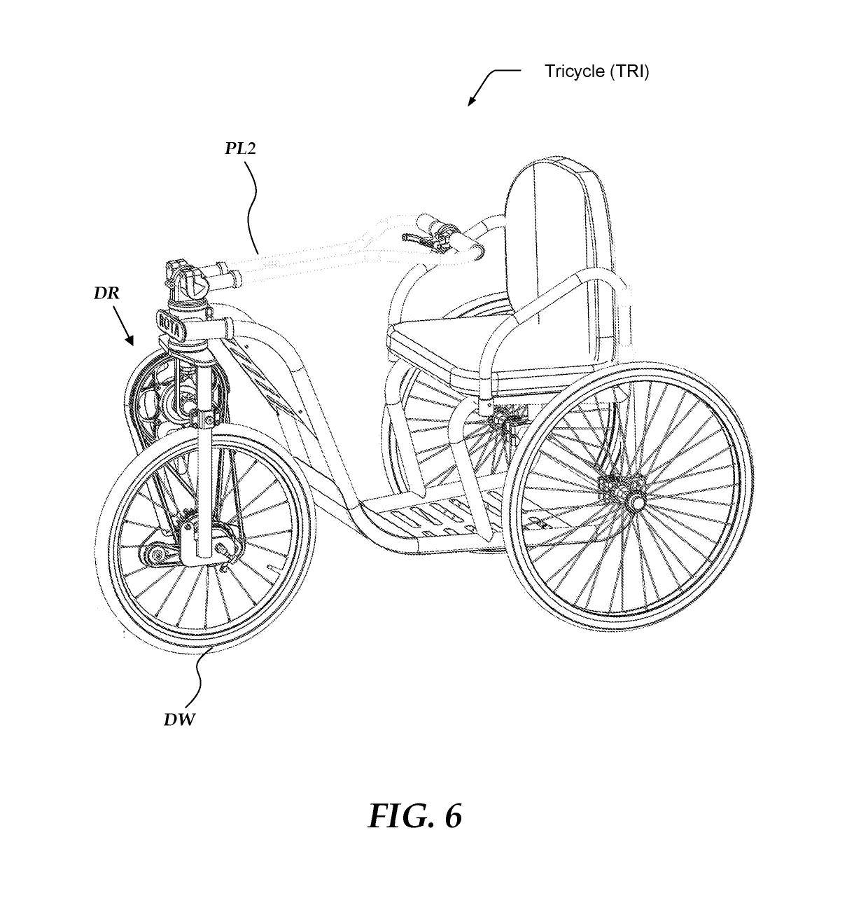

FIG. 6 is an illustration of an embodiment of a tricycle (TRI) that incorporates the reciprocal drive (DR). The tricycle (TRI) incorporates a propulsion lever (PL2) that includes a brake handle and a gear shifter. The user of the tricycle (TRI) employs a rowing motion to push and pull the propulsion lever (PL2). The reciprocal drive (DR) is attached to the chassis of the tricycle (TRI). It may be appreciated that in this embodiment reciprocal drive (DR) is illustrated as not including a housing. In certain embodiments reciprocal drive (DR) does not include a housing while in other embodiments a housing is included. As with other vehicles that incorporate the reciprocal drive (DR), the tricycle (TRI) also provides turret steering, i.e. the ability to rotate the reciprocal drive to any angle and to move in that direction.

While FIGS. 5A-5B and 6 depict several embodiments of vehicles that incorporate of the present invention they are not intended to limit the types of vehicles or the configurations of vehicles that incorporate the present invention. For example, although one embodiment of the present invention is one where one drive (front) wheel is outfitted to the vehicle, an embodiment wherein two drive (front or rear) wheels will readily be envisioned by one of ordinary skill in the mechanical arts.

In addition, while the term hand propelled or user or occupant powered are used to describe the role of the user in providing power to the reciprocal drive (DR) through a rowing motion, in certain embodiments the reciprocal drive (DR) may itself, for example through an electric motor, provide some of the power.

In reading the above description, persons skilled in the art will realize that there are many apparent variations that can be applied to the devices and systems described. In particular, embodiments of the reciprocal drive may include various combinations of gears, brakes, and wheels. Further, the reciprocal drive may be integrated within a variety of hand powered vehicles including scooter-type vehicles, wheel chairs, tricycles, paddle boats and the like.

What is claimed is:

1. A reciprocal drive for a hand powered vehicle comprising:
a first axle, connected to a propulsion lever that the occupant of the vehicle pushes and pulls in a rowing motion;
a first and a second power gear mounted on the first axle, wherein the first and second power gears rotate in opposing directions when the user pushes and pulls the propulsion lever;
a first and a second drive belt, wherein the first drive belt delivers propulsive force from the first power gear to a gear wheel when the user pushes the propulsion lever and the second drive belt delivers propulsive force from the second power gear to the gear wheel when the user pulls the propulsion lever; and
a second axle, on which the gear wheel is mounted, which rotates a drive wheel of the vehicle.

2. The reciprocal drive of claim 1 further comprising a first and a second clutch, also mounted on the axle, wherein the first clutch engages the first power gear when the user pushes the propulsion lever and the second clutch engages the second power gear when the user pulls the propulsion lever.

3. The reciprocal drive of claim 1 wherein the reciprocal drive is a rotatable module, allowing the drive wheel to be rotated to any angle, thereby permitting motion of the hand powered vehicle in any direction.

4. The reciprocal drive of claim 1 wherein the reciprocal drive is a rotatable module, allowing the drive wheel to be rotated 180 degrees, thereby permitting backward motion of the hand powered vehicle.

5. The reciprocal drive of claim 1, wherein the reciprocal drive is functionally integrated into a wheel chair.

6. The reciprocal drive of claim 1, wherein the reciprocal drive is functionally integrated into a scooter-type vehicle.

7. The reciprocal drive of claim 1, wherein the reciprocal drive is functionally integrated into a tricycle-type vehicle.

8. The reciprocal drive of claim 1, wherein the reciprocal drive is functionally integrated into a paddle boat.

9. The reciprocal drive of claim 1 further comprising a gearbox that includes variable gears, adjustable by the occupant of the vehicle.

10. The reciprocal drive of claim 1, wherein the first and second drive belts are metal chains.

11. The reciprocal drive of claim 1, wherein the first and second drive belts are rubber belts.

12. The reciprocal drive of claim 1 further comprising a disc-type braking mechanism.

13. The reciprocal drive of claim 1 further comprising a drum-type braking mechanism.

14. The reciprocal drive of claim 1, wherein the vehicle is equipped with 2 caster wheels in the front for added stability.

15. The reciprocal drive of claim 14, wherein the vehicle is further equipped with a control that enables the occupant of the vehicle to elevate the reciprocal drive, including the drive wheel, off the ground.
